(19) United States
(12) Patent Application Publication
(10) Pub. No.: US 2026/0089285 A1
(43) Pub. Date: Mar. 26, 2026

(54) IMAGE READING APPARATUS INCLUDING TWO IRRADIATION UNITS THAT IRRADIATE WITH LIGHT

(71) Applicant: CANON KABUSHIKI KAISHA, Tokyo (JP)

(72) Inventor: SATOSHI YOSHIDA, Saitama (JP)

(21) Appl. No.: 19/336,603

(22) Filed: Sep. 23, 2025

(30) Foreign Application Priority Data
Sep. 26, 2024 (JP) 2024-167825

(51) Int. Cl. H04N 1/40; H04N 1/00; H04N 1/409

(52) U.S. Cl. CPC H04N 1/40056; H04N 1/00588; H04N 1/4092; H04N 2201/0081

(57) ABSTRACT

An image reading apparatus includes: a reading unit configured to read a document being conveyed on a conveyance path, the reading unit including a first irradiation unit configured to irradiate with light from an upstream side of a reading position of the reading unit toward the reading position in a conveyance direction of the document, and a second irradiation unit configured to irradiate with light from a downstream side of the reading position toward the reading position; and a control unit configured to control light emission of the first irradiation unit and the second irradiation unit such that a light quantity by the first irradiation unit is larger than a light quantity by the second irradiation unit in a first range in a range of the conveyance path in a width direction orthogonal to the conveyance direction.

### BACKGROUND

### Field of the Technology

The present disclosure relates to an image reading apparatus that optically reads an image of a document being conveyed.

### Description of the Related Art

An image reading apparatus including an auto document feeder (ADF) is used. The ADF feeds documents placed on a document tray one by one to a conveyance path of the image reading apparatus. The image reading apparatus optically reads an image of a document while conveying the document along the conveyance path. In the image reading apparatus, skew in which the orientation of the document during conveyance deviates from an ideal orientation can occur due to various factors. The ideal orientation of the document at the time of conveyance is, for example, an orientation in which the side on a leading edge side in the conveyance direction of the document coincides with the width direction orthogonal to the conveyance direction. When skew occurs, an image read by the image reading apparatus also inclines obliquely.

Therefore, US-2019-0238703 discloses a technique of detecting a shadow cast by a side on the leading edge side of the document in the conveyance direction, thereby detecting an angle of the side on the leading edge side of the document with respect to the width direction, and correcting a read image based on the detected angle. Japanese Patent Laid-Open No. 2003-319160 discloses a configuration of applying a Laplacian filter to image data acquired by reading a document, in order to detect a shadow cast by a side on a leading edge side of the document.

When the shadow cast by the side on the leading edge side in the conveyance direction of the document is blurred, the shadow cannot be accurately detected even if the Laplacian filter is applied to the image data acquired by reading the document.

### SUMMARY

According to an aspect of the present disclosure, an image reading apparatus includes: a reading unit configured to read a document being conveyed on a conveyance path, the reading unit including a first irradiation unit configured to irradiate with light from an upstream side of a reading position of the reading unit toward the reading position in a conveyance direction of the document, and a second irradiation unit configured to irradiate with light from a downstream side of the reading position toward the reading position; and a control unit configured to control light emission of the first irradiation unit and the second irradiation unit such that a light quantity by the first irradiation unit is larger than a light quantity by the second irradiation unit in a first range in a range of the conveyance path in a width direction orthogonal to the conveyance direction.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a cross-sectional view of an image reading apparatus.

FIGS. 2A and 2B are configuration diagrams of a reading unit.

FIG. 3 is a view illustrating an example of a relationship between a position in a width direction and an irradiation light quantity by each of two irradiation units of the reading unit.

FIG. 4 is an explanatory view of a relationship between the irradiation light quantity of each of the two irradiation units of the reading unit and detection accuracy of a shadow.

FIG. 5 is a control block diagram of the image reading apparatus.

FIG. 6 is a flowchart of setting processing of control information.

FIG. 7 is an explanatory view of setting processing of control information.

FIG. 8 is an explanatory view of edge extraction processing.

FIG. 9 is a view illustrating an example of an image based on image data after edge extraction processing.

FIGS. 10A and 10B are explanatory views of correction processing.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

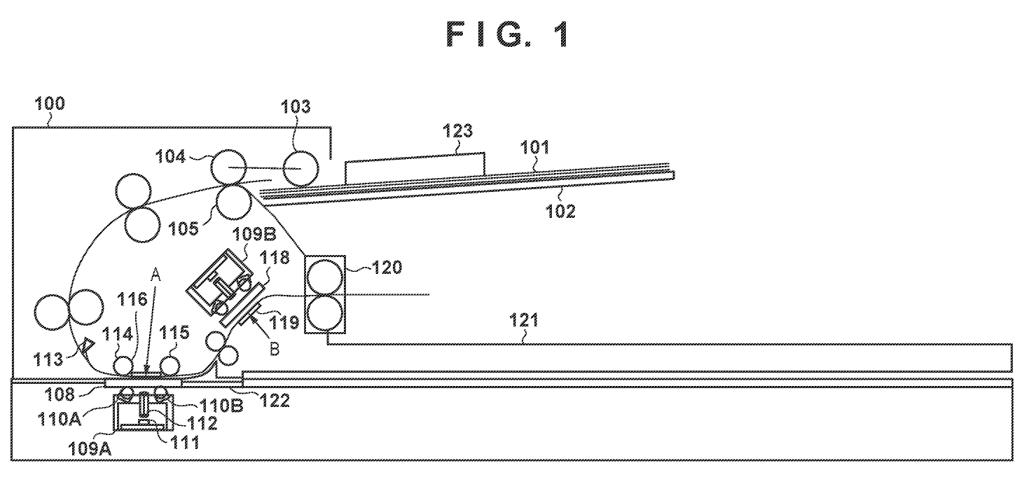

FIG. 1 is a cross-sectional view of an image reading apparatus 100 according to the present embodiment. Note that in the following description, unless it is clear from the context that it is not a conveyance direction or it is clearly stated that it is not the conveyance direction, a "leading edge of a document" means the leading edge of the document in the conveyance direction. One or more documents 101 are placed on a document tray 102. A side regulation plate 123 has two regulation members configured to be movable in the width direction. The two regulation members are configured such that the distance from the center in the width direction of the document tray 102 is the same regardless of the position in the width direction. The positions of the two sides parallel to the conveyance direction of the document 101 placed on the document tray 102 are regulated by the two regulation members, whereby the center in the width direction of the document 101 placed on the document tray 102 coincides with the center in the width direction of the document tray 102. At this time, the side on the leading edge side of the document 101 placed on the document tray 102 coincides with the width direction.

A pickup roller 103 feeds the topmost document 101 placed on the document tray 102 to a conveyance path of the image reading apparatus 100. Separation rollers 104 and 105 are provided to prevent double feeding of the document 101. The document 101 fed to the conveyance path is conveyed by a roller provided along the conveyance path.

A reading unit 109A reads a first surface of the document 101 at a reading position A. The reading position A is a position in the conveyance direction of the document 101. The reading unit 109A includes an irradiation unit 110A that irradiates the reading position A with light from the upstream side of the reading position A in the conveyance direction, and an irradiation unit 110B that irradiates the reading position A with light from the downstream side of the reading position A. The reading position A is provided with a guide plate 116, which is a white member. The guide plate 116 is a background member serving as a background of the document 101 at reading of the document 101 by the reading unit 109A. When the document 101 is not at the reading position A, the light irradiated by the irradiation unit 110A and the irradiation unit 110B is reflected by the guide plate 116, and when the document 101 is at the reading position A, the light irradiated by the irradiation unit 110A and the irradiation unit 110B is reflected by the document 101. Note that the irradiation unit 110A and the irradiation unit 110B irradiate the document 101 or the guide plate 116 with light via glass 108.

An optical member 112 forms an image on an image sensor 111 with reflected light irradiated from the irradiation unit 110A and the irradiation unit 110B and reflected by the document 101 or the guide plate 116. The image sensor 111 of the present embodiment has 7500 pixels along the width direction, and one pixel has three different light receiving elements that receive light of three colors of red (R), green (G), and blue (B). The image sensor 111 reads the document 101 conveyed in units of one line (7500 pixels) in the width direction. Image data corresponding to the document 101 is read by repeatedly reading the document 101 by the image sensor 111 while the document 101 is passing through the reading position A.

Pressure rollers 114 and 115 press the document 101, thereby stabilizing the distance between the reading unit 109A and the document 101. A reading unit 109B reads a second surface of the document 101 via the glass 118 at a reading position B on the downstream side of the reading position A. The configuration of the reading unit 109B is similar to the configuration of the reading unit 109A. The reading position B is provided with a guide plate 119, which is a white member. A sensor 113 detects the document 101 on the upstream side of the reading position A. The timing at which the sensor 113 detects the document 101 is used to determine the reading timing of the document 101 by the reading unit 109A and the reading unit 109B. The document 101 having passed through the reading position B is placed on a tray 121 by a roller 120. A white reference plate 122, which is a white member, is a measurement member or a reference member to be measured by the reading unit 109A in order to acquire shading data of the reading unit 109A. The reading unit 109A is configured to be movable to a position where the white reference plate 122 can be read. That is, the reading unit 109A is configured to be movable between a position where the reading position is the reading position A and a position where the reading position is the white reference plate 122.

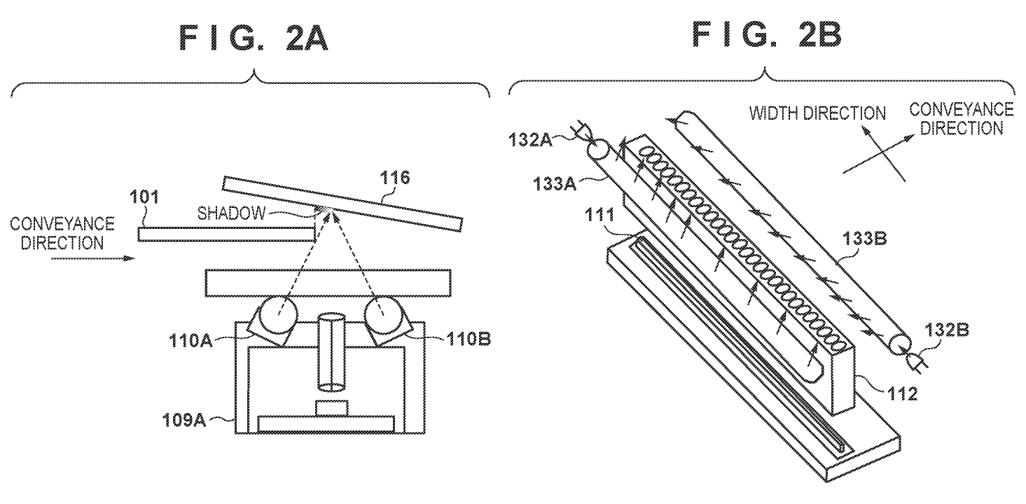

FIG. 2A is an enlarged view of the vicinity of the reading position A. As illustrated in FIG. 2A, when the reading unit 109A irradiates with light, a shadow due to the document 101 is cast on the leading edge side of the document 101. FIG. 2B is a detailed configuration diagram of the reading unit 109A. The irradiation unit 110A includes a light source 132A and a light guide 133A. The irradiation unit 110B includes a light source 132B and a light guide 133B. The light source 132A and the light source 132B are, for example, light emitting diodes (LED). The light guide 133A propagates, along the width direction, the light emitted from the light source 132A, and irradiates the reading position A with light in the process. Similarly, the light guide 133B propagates, along the width direction, the light emitted from the light source 132B, and irradiates the reading position A with light in the process. Note that the direction in which the light guide 133A propagates light is opposite to the direction in which the light guide 133B propagates light. Ideally, the light guide 133A and the light guide 133B uniformly irradiate with light along the width direction, but in practice, the irradiation light quantity with respect to the document 101 varies depending on the position in the width direction. Specifically, the irradiation light quantity by the light guide 133A decreases as the distance from the light source 132A increases in the width direction. Similarly, the irradiation light quantity by the light guide 133B decreases as the distance from the light source 132B increases in the width direction. By making propagation directions of light in the light guide 133A and the light guide 133B opposite each other, it is possible to reduce a difference in irradiation light quantity depending on the position in the width direction.

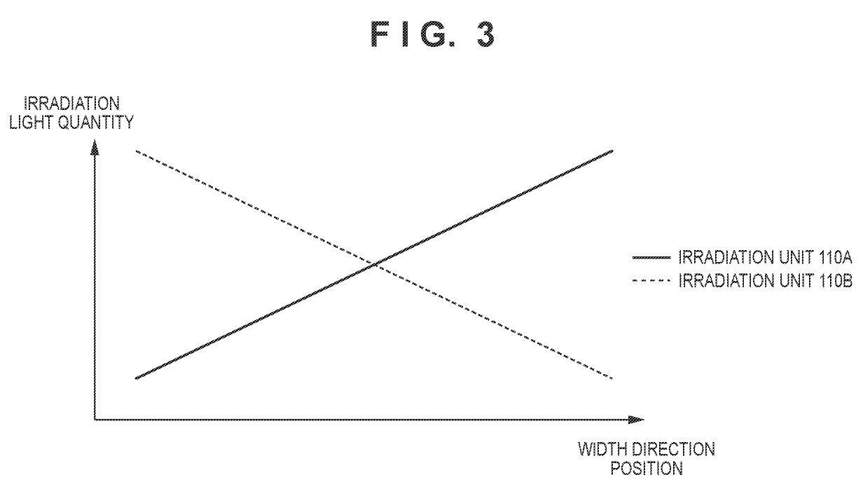

FIG. 3 illustrates an example of the relationship between the position in the width direction and the irradiation light quantities by the irradiation units 110A and 110B. Note that the solid line in FIG. 3 indicates the irradiation light quantity by the irradiation unit 110A, and the dotted line in FIG. 3 indicates the irradiation light quantity by the irradiation unit 110B. The irradiation unit 110A irradiates the reading position A with light from the upstream side of the reading position A, and the irradiation unit 110B irradiates the reading position A with light from the downstream side of the reading position A. As clear from FIG. 2A, it is the light from the irradiation unit 110A that creates the shadow on the leading edge side of the document 101, and the light from the irradiation unit 110B acts to erase the shadow on the leading edge side of the document 101. Therefore, the darkness of the shadow cast on the leading edge side of the document 101 varies depending on the position in the width direction. Specifically, the shadow becomes darker as the irradiation light quantity by the irradiation unit 110A becomes larger than the irradiation light quantity by the irradiation unit 110B.

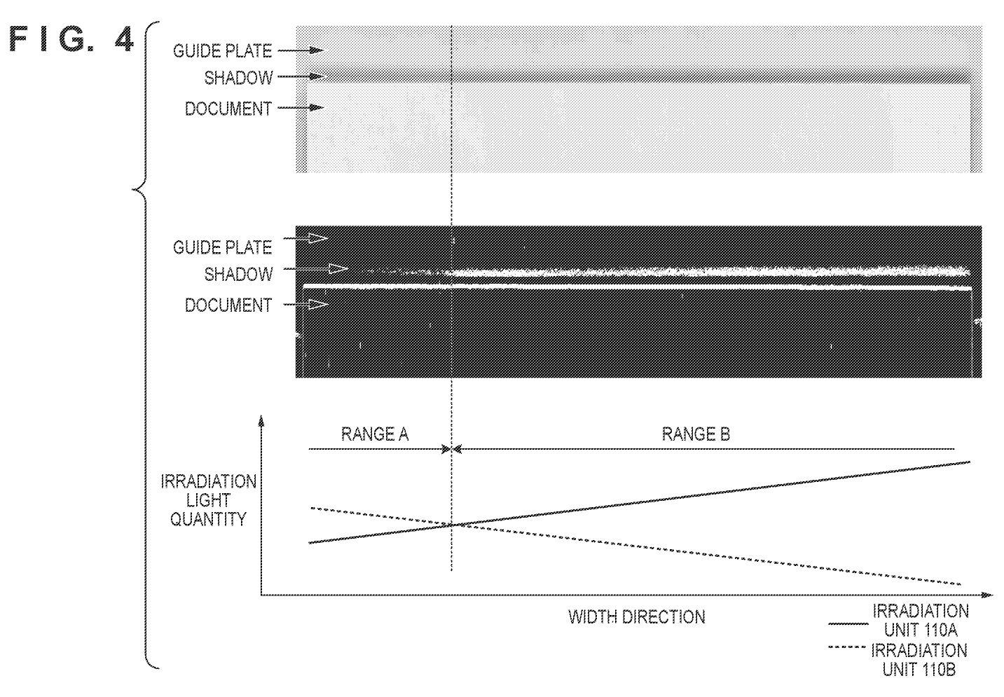

The upper side of FIG. 4 illustrates an image (hereinafter, a read image) based on image data read by the reading unit 109A. Reading by the reading unit 109A is started before the document 101 reaches the reading position A, and therefore the guide plate 116, the shadow cast on the leading edge side of the document 101, and the document 101 are read. The second from the top of FIG. 4 illustrates an image (hereinafter, an edge image) in which edge extraction processing (binarization processing) is performed on the image data read by the reading unit 109A. Note that a white part indicates the extracted edge. The lower side of FIG. 4 illustrates the irradiation light quantity by the irradiation unit 110A and the irradiation light quantity by the irradiation unit 110B when reading is performed by the reading unit 109A. As illustrated in FIG. 4, in a range B where the irradiation light quantity by the irradiation unit 110A is higher than the irradiation light quantity by the irradiation unit 110B, an edge (hereinafter, a shadow edge) between the guide plate 116 and the shadow is accurately extracted. ‎ On the other hand, in a range A where the irradiation light quantity by the irradiation unit 110A is lower than the irradiation light quantity by the irradiation unit 110B, the edge between the guide plate 116 and the shadow is not accurately extracted.

Therefore, it is understood that in order to accurately detect a shadow edge, the light emission of the light source 132A and the light source 132B may be controlled such that the irradiation light quantity by the irradiation unit 110A becomes larger than the irradiation light quantity by the irradiation unit 110B at least in a range (hereinafter, a document range) through which the document 101 passes, in the range of the conveyance path in the width direction.

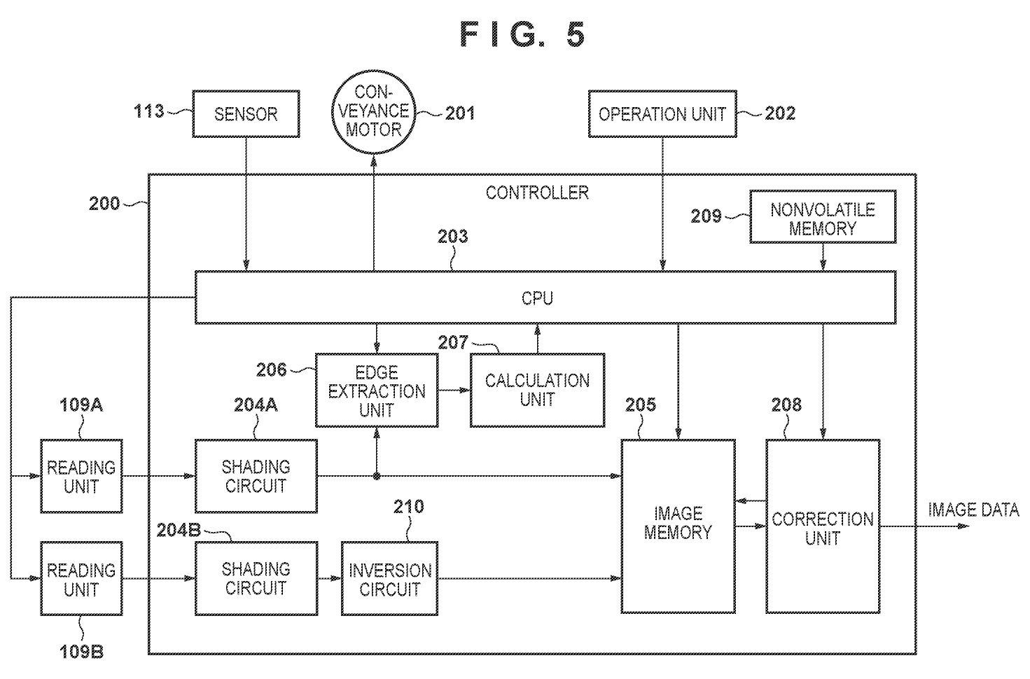

FIG. 5 is a control block diagram of the image reading apparatus 100. A controller 200 controls the entire image reading apparatus 100. A CPU 203 is a processor. Upon receiving a reading instruction of a document via an operation unit 202, the CPU 203 controls a conveyance motor 201 to control feeding and conveyance of the document 101 placed on the document tray 102. Then, the CPU 203 controls reading of the document 101 by the reading unit 109A and the reading unit 109B based on a detection result of the document 101 by the sensor 113. The reading unit 109A outputs first image data that is digital as a reading result of the first surface of the document 101, and the reading unit 109B outputs second image data that is digital as a reading result of the second surface of the document 101.

The first image data is transmitted to a shading circuit 204A, and the second image data is transmitted to a shading circuit 204B. By performing addition/subtraction and multiplication/division on the image data, the shading circuits 204A and 204B correct non-uniformity of the irradiation light quantities by the irradiation units 110A and 110B and the influence of sensitivity unevenness for each pixel of the image sensor 111, and generate image data uniform in the width direction.

The first image data after the shading correction is stored in an image memory 205. In order to make the width direction of the second image data after the shading correction same as the direction of the first image data, an inversion circuit 210 performs inversion processing in the width direction, and then the second image data is stored in the image memory 205. The first image data after the shading correction is also transmitted to an edge extraction unit 206. The edge extraction unit 206 performs edge extraction processing on the first image data after the shading correction to generate image data of the edge image described in FIG. 4. A calculation unit 207 generates and outputs, to the CPU 203, document information based on the image data of the edge image. Details of processing at the edge extraction unit 206 and the calculation unit 207 will be described later.

The CPU 203 outputs the document information to a correction unit 208. The correction unit 208 corrects the first image data and the second image data stored in the image memory 205 based on the document information. A nonvolatile memory 209 stores control information indicating light emission conditions of the light sources 132A and 132B. The CPU 203 causes the light source 132A to emit light based on a first light emission condition indicated by the control information stored in the nonvolatile memory 209, and causes the light source 132B to emit light based on a second light emission condition. The first light emission condition is a condition for controlling the light emission quantity of the light source 132A, and the second light emission condition is a condition for controlling the light emission quantity of the light source 132B. The light emission condition is, for example, a condition indicating the light emission intensity and the light emission time of the light source. Note that the light emission intensity can be designated by a drive current flowing through the light source.

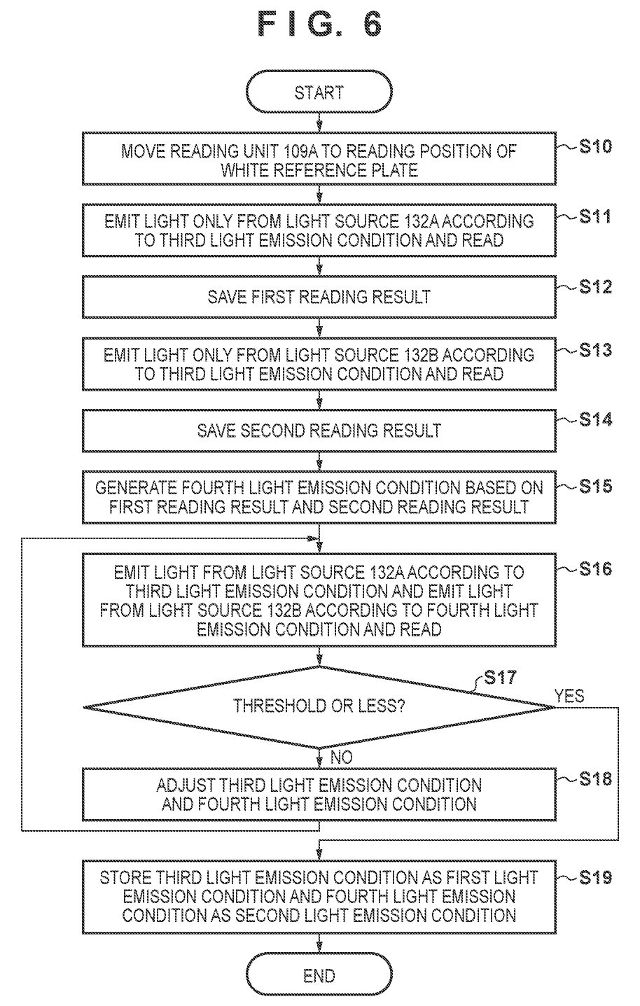

FIG. 6 is a flowchart of setting processing of the first light emission condition and the second light emission condition indicated by the control information stored in the nonvolatile memory 209. The setting processing is executed when instructed by the user via the operation unit 202 or when a predetermined condition is satisfied. In S10, the CPU 203 moves the reading unit 109A to a position where the white reference plate 122 can be read.

In S11, the CPU 203 causes only the light source 132A to emit light based on a third light emission condition, and causes the reading unit 109A to read the white reference plate 122. The third light emission condition is a predetermined condition stored in the nonvolatile memory 209 in advance. As an example, the third light emission condition is a condition in which the light emission time is 300 μs and the drive current is 50 mA. The reading result of the white reference plate 122 is a received light quantity of each pixel of the image sensor 111, that is, the irradiation light quantity at each position in the width direction, and can also be referred to as a luminance value. In S12, the CPU 203 saves, into the image memory 205, the reading result in S11 as the first reading result. In S13, the CPU 203 causes only the light source 132B to emit light based on the third light emission condition, and causes the reading unit 109A to read the white reference plate 122. In S14, the CPU 203 saves, into the image memory 205, the reading result in S13 as the second reading result.

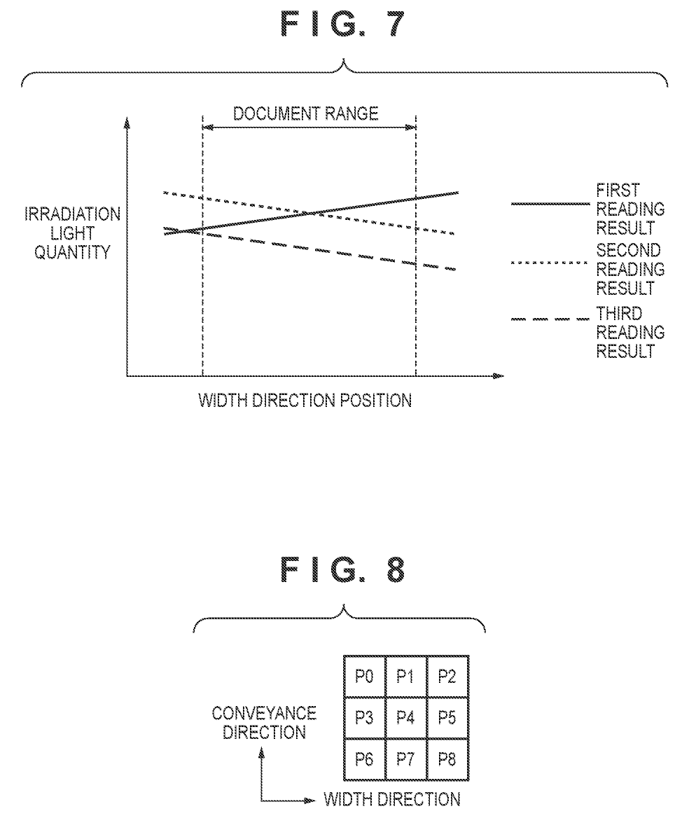

In S15, the CPU 203 generates a fourth light emission condition based on the first reading result and the second reading result. The fourth light emission condition is a condition in which the irradiation light quantity at each position in the document range when only the light source 132B is caused to emit light based on the fourth light emission condition and the white reference plate 122 is read is made smaller than the irradiation light quantity at the same position indicated by the first reading result. FIG. 7 illustrates an example of a relationship among the first reading result, the second reading result, and a third reading result. Note that the third reading result is a reading result when only the light source 132B is caused to emit light based on the fourth light emission condition to read the white reference plate 122. The third reading result is basically the second reading result shifted by a difference between the light emission quantity of the light source 132B based on the third light emission condition and the light emission quantity of the light source 132B based on the fourth light emission condition.

Returning to FIG. 6, in S16, the CPU 203 causes the light source 132A to emit light based on the third light emission condition and causes the light source 132B to emit light based on the fourth light emission condition to cause the reading unit 109A to read the white reference plate 122 to acquire a fourth reading result. The CPU 203 determines whether the total irradiation light quantity at each position in the width direction indicated by the fourth reading result is a predetermined threshold or less. When the total irradiation light quantity at each position is the predetermined threshold or less, the CPU 203 stores, into the nonvolatile memory 209, the third light emission condition as the first light emission condition and the fourth light emission condition as the second light emission condition in S19.

When the total irradiation light quantity at each position is not the predetermined threshold or less, the CPU 203 determines that the image sensor 111 is saturated. In this case, in S18, the CPU 203 repeats the processing from S16 by adjusting the third light emission condition and the fourth light emission condition so as to reduce the light emission quantity of the light source 132A and the light emission quantity of the light source 132B by the same ratio. Note that the CPU 203 can reduce the light emission quantity by controlling one or both of the light emission time and the drive current.

When the total irradiation light quantity at each position in the width direction indicated by the fourth reading result in S17 becomes the predetermined threshold or less, the CPU 203 stores, into the nonvolatile memory 209, the adjusted third light emission condition as the first light emission condition and the adjusted fourth light emission condition as the second light emission condition in S19. Note that a configuration of not making the total irradiation light quantity at each position in the entire range in the width direction to be read by the reading unit 109A a predetermined threshold or less but making the total irradiation light quantity at each position in the document range a predetermined threshold or less may be adopted.

At the time of reading the document, the CPU 203 causes the light source 132A to emit light based on the first light emission condition, and causes the light source 132B to emit light based on the second light emission condition. This configuration can cast a dark shadow, that is, a clear shadow on the leading edge side of the document 101. The document 101 can be read without saturating the image sensor 111.

Note that in FIG. 6, the fourth light emission condition in which the irradiation light quantity at each position in the document range when only the light source 132B is caused to emit light to read the white reference plate 122 made smaller than the irradiation light quantity at the same position indicated by the first reading result is determined based on the first reading result and the second reading result. However, a configuration can be adopted in which a fifth light emission condition in which the irradiation light quantity at each position in the document range when only the light source 132A is caused to emit light to read the white reference plate 122 made larger than the irradiation light quantity at the same position indicated by the second reading result is determined based on the first reading result and the second reading result. In this case, the CPU 203 acquires the fourth reading result by causing the reading unit 109A to read the white reference plate 122 in a state of causing the light source 132B to emit light based on the third light emission condition and causing the light source 132A to emit light based on the fifth light emission condition. When the total irradiation light quantity at each position in the width direction indicated by the fourth reading result is not the predetermined threshold or less, the CPU 203 adjusts the third light emission condition and the fifth light emission condition so as to reduce the light emission quantity of the light source 132B and the light emission quantity of the light source 132A by the same ratio. Then, the CPU 203 sets the third light emission condition as the second light emission condition, and sets the fifth light emission condition as the first light emission condition.

In FIG. 6, the first reading result and the second reading result are acquired, and the fourth light emission condition is determined based on the first reading result and the second reading result. However, a configuration may be adopted in which the fourth light emission condition is determined by repeatedly acquiring the reading result while causing the light source 132B to emit light under various conditions so that the irradiation light quantity at each position in the document range becomes smaller than the irradiation light quantity at the same position in the first reading result, after the acquisition of the first reading result. Similarly, a configuration may be adopted in which the fifth light emission condition is determined by causing the light source 132A to emit light under various conditions so that the irradiation light quantity at each position in the document range becomes larger than the irradiation light quantity at the same position in the second reading result, after the acquisition of the second reading result under the third light emission condition.

Furthermore, in FIG. 6, the first light emission condition and the second light emission condition are set using the third light emission condition, but in a case where the second light emission condition that does not saturate the image sensor 111 can be set based on the first light emission condition, a configuration in which the second light emission condition is set based on the first light emission condition can be adopted.

For example, the CPU 203 causes only the light source 132A to emit light in accordance with the first light emission condition to acquire the first reading result, and causes only the light source 132B to emit light in accordance with the first light emission condition to acquire the second reading result. Then, based on the first reading result and the second reading result, the CPU 203 can set the second light emission condition in which the irradiation light quantity at each position in the document range when the white reference plate 122 is read in a state where only the light source 132B is caused to emit light is smaller than the irradiation light quantity at the same position indicated by the first reading result.

Alternatively, the CPU 203 can set the second light emission condition by repeating, while varying the light emission quantity of the light source 132B, reading the white reference plate 122 in a state of causing only the light source 132B to emit light, after acquiring the first reading result.

Similarly, in a case where the first light emission condition that does not saturate the image sensor 111 can be set based on the second light emission condition, a configuration in which the first light emission condition is set based on the second light emission condition can be adopted.

For example, the CPU 203 causes only the light source 132A to emit light in accordance with the second light emission condition to acquire the first reading result, and causes only the light source 132B to emit light in accordance with the second light emission condition to acquire the second reading result. Then, based on the first reading result and the second reading result, the CPU 203 can set the first light emission condition in which the irradiation light quantity at each position in the document range when the white reference plate 122 is read in a state where only the light source 132A is caused to emit light larger than the irradiation light quantity at the same position indicated by the second reading result.

Alternatively, the CPU 203 can set the first light emission condition by repeating, while varying the light emission quantity of the light source 132A, reading the white reference plate 122 in a state of causing only the light source 132A to emit light, after acquiring only the second reading result.

In FIG. 6, the white reference plate 122 is used as a measurement member, and the first light emission condition and the second light emission condition are determined based on the reading result thereof. However, a configuration may be adopted in which the white guide plate 116 is used as a measurement member, and the first light emission condition and the second light emission condition are determined based on the reading result of the guide plate 116. Furthermore, in the present embodiment, the fourth light emission condition is a condition in which the irradiation light quantity at each position in the document range when only the light source 132B is caused to emit light is smaller than the irradiation light quantity at the same position in the first reading result. However, a condition in which the entire irradiation light quantity in the document range when only the light source 132B is caused to emit light, that is, the integral value of the irradiation light quantity at each position is made smaller than the entire irradiation light quantity in the document range indicated by the first reading result can be the fourth light emission condition. The same applies to the fifth light emission condition. That is, a condition in which the entire irradiation light quantity in the document range when only the light source 132A is caused to emit light is made larger than the entire irradiation light quantity in the document range indicated by the second reading result can be the fifth light emission condition.

FIG. 8 illustrates an example of a filter used in the edge extraction processing at the edge extraction unit 206. The edge extraction processing is also binarization processing. The filter illustrated in FIG. 8 is a filter of 3 × 3 pixels. The edge extraction unit 206 applies the first image data from the shading circuit 204A with the filter illustrated in FIG. 8, and determines the irradiation light quantity (luminance value) of the pixel corresponding to the filter of the first image data. As clear from the upper image of FIG. 4, when an edge exists in a region to be applied with the filter, the maximum value of the difference in the luminance values of the nine pixels increases. On the other hand, when no edge exists in the region to be applied with the filter, the maximum value of the difference in the luminance values of the nine pixels decreases. Therefore, when the maximum value of the difference in the luminance values of the nine pixels is larger than a threshold, the edge extraction unit 206 determines a center pixel, that is, the pixel of the first image data corresponding to P4 in FIG. 8, as an edge pixel. The edge extraction unit 206 determines the edge pixels while shifting the region to be applied with the filter in the document area. As described above, the edge extraction unit 206 outputs edge image data after the edge extraction processing to the calculation unit 207.

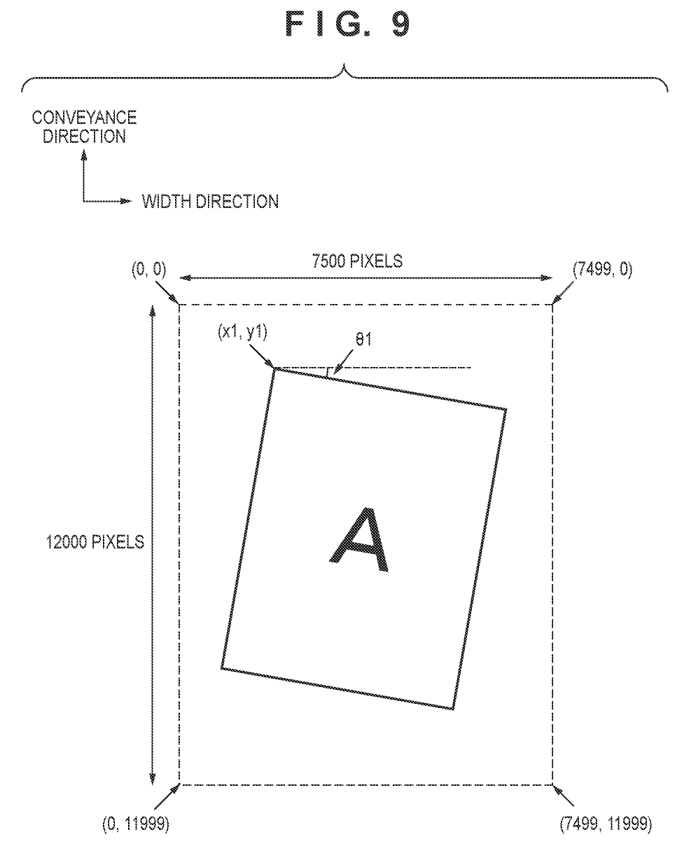

FIG. 9 is an image indicated by the edge image data. As described above, since reading by the reading unit 109A is performed before the document 101 reaches the reading position A, the edge image data of the image in the range indicated by the dotted line in FIG. 9 is input to the calculation unit 207. As described above, since the image sensor 111 has 7500 pixels, the number of pixels in the width direction is 7500. According to FIG. 9, the number of pixels in the conveyance direction is 12000. In the following description, with the upper left pixel in FIG. 9 as the origin, the position of the pixel that is x-th along the width direction from the origin and y-th along the direction opposite to the conveyance direction from the origin is referred to as a position (x-1, y-1).

The calculation unit 207 determines a document leading edge angle θ1 and a position (x1, y1) of the pixel in the edge image data on the leading edge left side of the document 101 based on the shadow on the leading edge side of the document 101, and transmits document information indicating the document leading edge angle θ1 and the position (x1, y1) to the CPU 203. The CPU 203 transmits the document information to the correction unit 208.

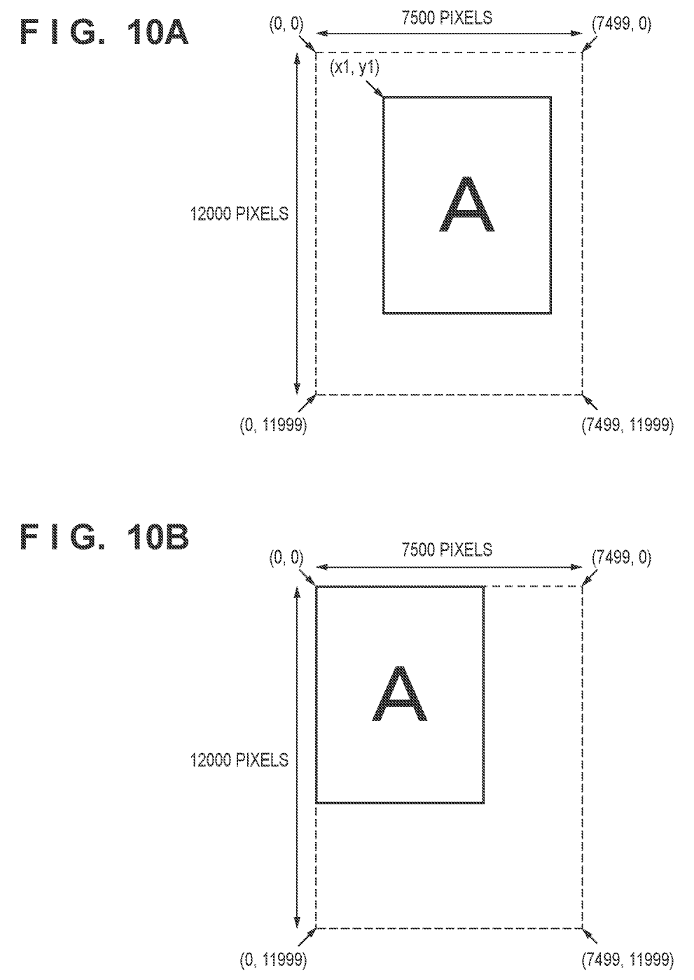

The correction unit 208 performs rotation correction of the first image data and the second image data stored in the image memory 205 based on the document leading edge angle θ1. FIG. 10A illustrates an image after the rotation correction of the first image data. Subsequently, the correction unit 208 performs, on the first image data and the second image data after the rotation correction, shift correction of shifting the document position so that the position (x1, y1) on the leading edge left side becomes the origin. FIG. 10B illustrates an image after the shift correction of the first image data.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-167825, filed September 26, 2024, which is hereby incorporated by reference herein in its entirety.

What is claimed is:

1. An image reading apparatus comprising:
a reading unit configured to read a document being conveyed on a conveyance path, the reading unit including a first irradiation unit configured to irradiate with light from an upstream side of a reading position of the reading unit toward the reading position in a conveyance direction of the document, and a second irradiation unit configured to irradiate with light from a downstream side of the reading position toward the reading position; and
a control unit configured to control light emission of the first irradiation unit and the second irradiation unit such that a light quantity by the first irradiation unit is larger than a light quantity by the second irradiation unit in a first range in a range of the conveyance path in a width direction orthogonal to the conveyance direction.

2. The image reading apparatus according to claim 1, wherein the first range includes a range through which the document passes in the conveyance path.

3. The image reading apparatus according to claim 1, wherein
the first irradiation unit includes a first light source and a first light guide configured to irradiate the reading position with light from the first light source while propagating the light in the width direction,
the second irradiation unit includes a second light source and a second light guide configured to irradiate the reading position with light from the second light source while propagating the light in a direction opposite to the first light guide in the width direction, and
the control unit is configured to control light emission of the first irradiation unit and the second irradiation unit by controlling light emission quantities of the first light source and the second light source.

4. The image reading apparatus according to claim 3, wherein the control unit is configured to control light emission quantities of the first light source and the second light source by controlling at least one of light emission intensity and light emission time of the first light source and the second light source.

5. The image reading apparatus according to claim 3,further comprising:
a storage unit configured to store control information, wherein
the control unit is configured to control light emission of the first light source in accordance with a first light emission condition indicated by the control information and control light emission of the second light source in accordance with a second light emission condition indicated by the control information when reading the document.

6. The image reading apparatus according to claim 5, wherein the control unit is configured to acquire a first reading result indicating a relationship between a position in the width direction and a light quantity by reading a measurement member in a state of causing only the first light source to emit light in accordance with a third light emission condition, acquire a second reading result indicating a relationship between a position in the width direction and a light quantity by reading the measurement member in a state of causing only the second light source to emit light in accordance with the third light emission condition, and set the first light emission condition and the second light emission condition based on the first reading result and the second reading result.

7. The image reading apparatus according to claim 6, wherein
the control unit is configured to
obtain, based on the first reading result and the second reading result, a fourth light emission condition in which a light quantity in the first range when the measurement member is read in a state of causing only the second light source to emit light is made smaller than a light quantity in the first range indicated by the first reading result, and
by reading the measurement member in a state of causing the first light source to emit light in accordance with the third light emission condition and the second light source to emit light in accordance with the fourth light emission condition, acquire a third reading result indicating a relationship between a position in the width direction and a light quantity, adjust, at a same ratio, a light emission quantity of the first light source in accordance with the third light emission condition and a light emission quantity of the second light source in accordance with the fourth light emission condition so that a light quantity at each position in the width direction indicated by the third reading result is a predetermined threshold or less, and set the third light emission condition after adjustment as the first light emission condition, and the fourth light emission condition after adjustment as the second light emission condition.

8. The image reading apparatus according to claim 6, wherein
the control unit is configured to
obtain, based on the first reading result and the second reading result, a fifth light emission condition in which a light quantity in the first range when the measurement member is read in a state of causing only the first light source to emit light is made larger than a light quantity in the first range indicated by the second reading result, and
by reading the measurement member in a state of causing the first light source to emit light in accordance with the fifth light emission condition and the second light source to emit light in accordance with the third light emission condition, acquire a third reading result indicating a relationship between a position in the width direction and a light quantity, adjust, at a same ratio, a light emission quantity of the first light source in accordance with the fifth light emission condition and a light emission quantity of the second light source in accordance with the third light emission condition so that a light quantity at each position in the width direction indicated by the third reading result is a predetermined threshold or less, and set the fifth light emission condition after adjustment as the first light emission condition, and the third light emission condition after adjustment as the second light emission condition.

9. The image reading apparatus according to claim 5, wherein
the control unit is configured to
acquire a first reading result indicating a relationship between a position in the width direction and a light quantity by reading a measurement member in a state of causing only the first light source to emit light in accordance with a third light emission condition, and obtain a fourth light emission condition in which a light quantity in the first range is made smaller than a light quantity in the first range indicated by the first reading result by repeating, while varying a light emission quantity of the second light source, reading the measurement member in a state of causing only the second light source to emit light, and
by reading the measurement member in a state of causing the first light source to emit light in accordance with the third light emission condition and the second light source to emit light in accordance with the fourth light emission condition, acquire a third reading result indicating a relationship between a position in the width direction and a light quantity, adjust, at a same ratio, a light emission quantity of the first light source in accordance with the third light emission condition and a light emission quantity of the second light source in accordance with the fourth light emission condition so that a light quantity at each position in the width direction indicated by the third reading result is a predetermined threshold or less, and set the third light emission condition after adjustment as the first light emission condition, and the fourth light emission condition after adjustment as the second light emission condition.

10. The image reading apparatus according to claim 5, wherein
the control unit is configured to
acquire a second reading result indicating a relationship between a position in the width direction and a light quantity by reading a measurement member in a state of causing only the second light source to emit light in accordance with a third light emission condition, and obtain a fifth light emission condition in which a light quantity in the first range is made larger than a light quantity in the first range indicated by the second reading result by repeating, while varying a light emission quantity of the first light source, reading the measurement member in a state of causing only the first light source to emit light, and
by reading the measurement member in a state of causing the first light source to emit light in accordance with the fifth light emission condition and the second light source to emit light in accordance with the third light emission condition, acquire a third reading result indicating a relationship between a position in the width direction and a light quantity, adjust, at a same ratio, a light emission quantity of the first light source in accordance with the fifth light emission condition and a light emission quantity of the second light source in accordance with the third light emission condition so that a light quantity at each position in the width direction indicated by the third reading result is a predetermined threshold or less, and set the fifth light emission condition after adjustment as the first light emission condition, and the third light emission condition after adjustment as the second light emission condition.

11. The image reading apparatus according to claim 5, wherein the control unit is configured to acquire a first reading result indicating a relationship between a position in the width direction and a light quantity by reading a measurement member in a state of causing only the first light source to emit light in accordance with the first light emission condition, acquire a second reading result indicating a relationship between a position in the width direction and a light quantity by reading the measurement member in a state of causing only the second light source to emit light in accordance with the first light emission condition, and set the second light emission condition in which a light quantity in the first range when the measurement member is read in a state of causing only the second light source to emit light is made smaller than a light quantity in the first range indicated by the first reading result based on the first reading result and the second reading result.

12. The image reading apparatus according to claim 5, wherein the control unit is configured to acquire a first reading result indicating a relationship between a position in the width direction and a light quantity by reading a measurement member in a state of causing only the first light source to emit light in accordance with the first light emission condition, and set the second light emission condition in which a light quantity in the first range is made smaller than a light quantity in the first range indicated by the first reading result by repeating, while varying a light emission quantity of the second light source, reading the measurement member present at the reading position in a state of causing only the second light source to emit light.

13. The image reading apparatus according to claim 5, wherein the control unit is configured to acquire a second reading result indicating a relationship between a position in the width direction and a light quantity by reading a measurement member in a state of causing only the second light source to emit light in accordance with the second light emission condition, acquire a first reading result indicating a relationship between a position in the width direction and a light quantity by reading the measurement member in a state of causing only the first light source to emit light in accordance with the second light emission condition, and set the first light emission condition in which a light quantity in the first range when the measurement member is read in a state of causing only the first light source to emit light is made larger than a light quantity in the first range indicated by the second reading result based on the first reading result and the second reading result.

14. The image reading apparatus according to claim 5, wherein the control unit is configured to acquire a second reading result indicating a relationship between a position in the width direction and a light quantity by reading a measurement member in a state of causing only the second light source to emit light in accordance with the second light emission condition, and set the first light emission condition in which a light quantity in the first range is made larger than a light quantity in the first range indicated by the second reading result by repeating, while varying a light emission quantity of the first light source, reading the measurement member in a state of causing only the first light source to emit light.

15. The image reading apparatus according to claim 6, wherein the third light emission condition is a predetermined condition.

16. The image reading apparatus according to claim 6, wherein the measurement member is a white member.

17. The image reading apparatus according to claim 6, wherein the measurement member is a background member when the reading unit reads a document.

18. The image reading apparatus according to claim 6, wherein the control unit moves the reading unit such that the measurement member is located at the reading position of the reading unit when causing the reading unit to read the measurement member.

19. The image reading apparatus according to claim 5, wherein at each position in the first range, a light quantity by the first irradiation unit when the first light source is caused to emit light in accordance with the first light emission condition is larger than a light quantity by the second irradiation unit when the second light source is caused to emit light in accordance with the second light emission condition.

20. The image reading apparatus according to claim 5, wherein an entire light quantity of the first range irradiated by the first irradiation unit when the first light source is caused to emit light in accordance with the first light emission condition is larger than an entire light quantity of the first range irradiated by the second irradiation unit when the second light source is caused to emit light in accordance with the second light emission condition.
